(19) United States
(12) Patent Application Publication
(10) Pub. No.: US 2019/0065851 A1
(43) Pub. Date: Feb. 28, 2019

(54) SYSTEM AND METHOD FOR PROGRAMMATIC IDENTIFICATION AND CROSS-PLATFORM REGISTRATION OF HARDWARE PRODUCTS VIA VISUAL OBJECT RECOGNITION

(71) Applicant: AVID RATINGS, Madison, WI (US)

(72) Inventor: Paul Cardis, Madison, WI (US)

(21) Appl. No.: 16/117,420

(22) Filed: Aug. 30, 2018

Related U.S. Application Data
(60) Provisional application No. 62/551,853, filed on Aug. 30, 2017.

(51) Int. Cl. G06K 9/00; H04N 5/232; G06Q 40/08

(52) U.S. Cl. CPC G06K 9/00664; H04N 5/23206; H04L 67/12; G06Q 40/08; H04N 5/23222

(57) ABSTRACT

A server-based system includes data collectors configured to capture at least identification data for hardware products in a defined area. Data collectors may be mobile (e.g. smartphones or dedicated data capturing devices) or fixed in a given area, and may be voice enabled to capture data or prompt users in the defined area. The server automatically identifies each of the associated hardware products based on the at least identification data from the data collectors, further in association with a time the data was captured and an authenticated location of the defined area. The server further selectively actuate one or more program applications via a user computing device located in the defined area. For example, an insurer platform may be notified with respect to certain identified and authenticated hardware products, and even updated valuations associated with the defined area. A registration platform may enable automatic registration of identified hardware products.

### CROSS-REFERENCES TO RELATED APPLICATIONS

This application claims benefit of U.S. Provisional Patent Application No. 62/551,853, filed Aug. 30, 2017, and which is hereby incorporated by reference.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND

Various embodiments of an invention as disclosed herein relate to simplifying or otherwise facilitating user identification of hardware products in a defined area. More particularly, an invention as disclosed herein relates to a server-based system including local data collectors configured to automatically identify a plurality of hardware products, and enable quick, easy and improved product registration, user review, valuation and the like.

Today's customers approach home buying from many angles and demand as much information as possible before making a decision. The advent of internet marketing, as well as immediate accessibility to information across multiple social networks and digital platforms, has changed the way people make purchases—from groceries to furniture to homes. From the moment customers start shopping, they expect data, customer reviews, photos and virtual tours. These tools provide crucial metrics by which customers now make decisions on all of their major purchases. However, widespread access to information regarding the components of a home remains surprisingly elusive to most consumers.

Once a homeowner/tenant takes possession of a new home or property, they may receive one or more registration or warranty cards, manuals and the like regarding hardware products installed therein. The term “hardware products” as used herein may refer to transient components such as appliances or lighting fixtures, as well as more permanently affixed components such as windows, flooring, heating, ventilation and air conditioning (HVAC) systems and other such features installed in the home. However, it is generally understood that most users will never fill out and mail the registration or warranty cards to the appropriate manufacturers, often because of the requisite hassle involved in identifying and locating the given products and product information, aside from the common opinion that registrations or warranties are only of peripheral importance, especially for relatively new products.

In addition, for legacy hardware products in previously existing homes or properties, new users will only infrequently be presented with an opportunity to review or update such information. These hardware products may be two years old or twenty years old, under warranty or not, without a new consumer being any the wiser at the time of purchase.

It would therefore be desirable for consumers (or even existing owners/tenants/lessees) to have access to more information regarding the type, quality and status of various hardware products and other components in their home or property. For example, the user may benefit greatly from knowing not only what type and age of hardware product is at issue, but also who installed the hardware product, and how much or how well regarded are optional replacements for said hardware product or potential alternative installers of said hardware product. Where did the hardware products or associated materials originate? How were they made? Are they environmentally friendly? How have the hardware products or associated providers been reviewed and rated by prior users, and are such reviews reliable?

It would further be desirable in certain applications for such comprehensive information to be available to prospective buyers, based on a preliminary analysis of the home or property during the purchasing process. However, few sellers or buyers are so proactive, particularly in view of the difficulties in easily and accurately obtaining such information using conventional tools.

### BRIEF SUMMARY

Exemplary systems or methods according to the present disclosure provide for computer-assisted identification of hardware products via optically based, software-enabled object recognition and subsequent, software-assisted registration of and user review dissemination of the hardware products via a mobile device.

An embodiment of a system as disclosed herein includes one or more data collectors configured to capture at least identification data for one or more hardware products in a defined area. A server is configured to automatically identify each of the associated one or more hardware products based on the identification data from the data collectors, further in association with a time at which the identification data was captured and an authenticated location of the defined area with respect to the one or more hardware products. The server further selectively actuates one or more program applications via a user computing device located in the defined area, each program application respectively associated with one or more of the identified hardware products.

In another embodiment, at least one of the data collectors is an imaging device such as a camera configured to capture images including at least one of the hardware products, and the server is configured to automatically identify hardware products in the captured images via at least image recognition processing and contextual data associated with the captured image.

In another embodiment at least one of the data collectors is fixed in position with the respect to the defined area, and comprises a wireless transceiver configured to receive wireless messages comprising identification data from one or more of the hardware products. The at least one fixed data collector may be configured to actuate capture of the identification data from the wireless messages from the one or more of the hardware products pursuant to a received audio command. The at least one fixed data collector may be further configured to audibly prompt additional capture of identification data via a mobile user computing device as another of the one or more data collectors. The mobile user computing device may include an imaging device such as a camera, wherein the server is configured to automatically identify at least one hardware product in the captured images via at least image recognition processing and contextual data associated therewith.

In another embodiment, the server is configured to prompt a user via a fixed data collector or a user interface associated with a mobile user computing device to capture one or more additional images until a confidence level is acquired in the hardware product identification.

In another embodiment, the server is configured to compare a first set of identified hardware products based on the wireless messages received via the at least one fixed data collector against a stored plurality of expected hardware products in the defined area. The server further directs at least one fixed data collector to audibly prompt additional capture of identification data for at least a remaining second set of hardware products of the stored plurality of expected hardware products.

In another embodiment, at least one of the data collectors comprises an imaging device associated with a first mobile user computing device, and the first mobile user computing device further comprises a position sensor for server-based authentication of the location of the defined area with respect to the identified hardware products at a first time. The server is further configured to selectively actuate one or more program applications via a second mobile user computing device authenticated as being located in the defined area at a second time, each program application respectively associated with one or more of the identified hardware products.

In another embodiment, the server is configured in association with at least one of the selectively actuated program applications to determine one or more of the identified hardware products for online submission of hardware product information to an insurance entity platform. The server selectively prompts a user via at least one of the data collectors or the user computing device to provide at least a position authentication with respect to the determined one or more of the identified hardware products, within a specified period of time, and finally submits the hardware product information to the insurance entity platform along with the time-based position authentication.

In another embodiment, the server is configured in association with at least one of the selectively actuated program applications to transmit hardware product information for the identified hardware products to a valuation platform and, pursuant to an updated valuation associated with the defined area and received from the valuation platform, to submit the updated valuation to the insurance entity platform along with the time-based position authentication.

In another embodiment, the server is configured to determine one or more of the identified hardware products for which registration is available on one or more registration platforms and, in association with at least one of the selectively actuated program applications, generating registration data transmittal for one or more of the identified hardware products to the respective registration platforms. The server may further be configured to prompt a user, via at least one of the data collectors or a user interface associated with the mobile user computing device, for additional information associated with registration of the determined one or more hardware products, based at least on defined input requirements for any one or more of the registration platforms.

In another embodiment, the server is configured in association with at least one of the selectively actuated program applications to determine one or more of the identified hardware products for which online submission of user review is available on one or more third party product review aggregating platforms. One or more product reviews are generated from a single user input string associated with an identified hardware product, based at least on the respective review data input requirements for each of the respective third party product review aggregating platforms, and distributed to the respective third party product review aggregating platforms.

### BRIEF DESCRIPTION OF THE SEVERAL VIEWS OF THE DRAWINGS

FIG. 1 is a block diagram representing an embodiment of a system for computer-assisted identification of hardware products via optically based, software-enabled object recognition and subsequent, software-assisted registration of and user review dissemination of the hardware products via a mobile device.

FIG. 2 is a flow diagram representing an embodiment of a process for optical object recognition and identification of hardware products as implemented by the system of FIG. 1.

FIG. 3 is a flow diagram representing an embodiment of a process for assisting a user in registering and reviewing the identified hardware products as implemented by the system of FIG. 1.

FIG. 4 is a flow diagram representing an embodiment of a process for determining a financial valuation of hardware products as identified by the process of FIG. 2 and implemented by the system of FIG. 1.

FIG. 5 is a flow diagram representing an embodiment of a process for configuring a hardware device upon installation for assisted user registration as described in FIG. 3 and implemented by the system of FIG. 1.

### DETAILED DESCRIPTION

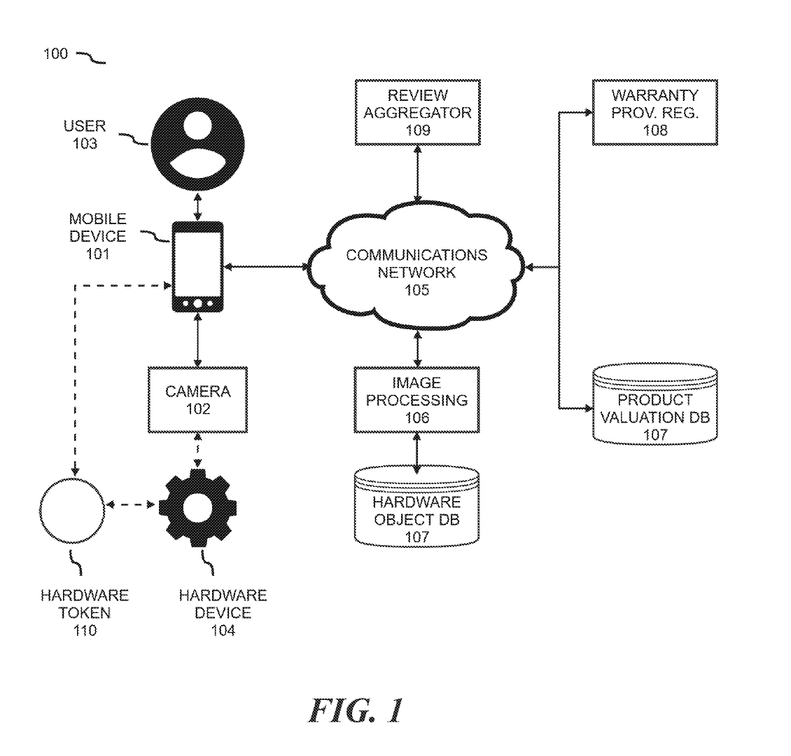

Referring generally to FIGS. 1-5, various exemplary embodiments of an invention may now be described in detail. Where the various figures may describe embodiments sharing various common elements and features with other embodiments, similar elements and features are given the same reference numerals and redundant description thereof may be omitted below.

In one aspect as disclosed herein, embodiments of a hosted system or method may take the form of a user application interface as delivered via a mobile application, website, or the like. The user application interface may in various embodiments be configured to receive visual data from a communicatively connected camera device and categorize the visual data for subsequent software-based extrapolation of data therefrom, such as via image object recognition algorithms and processing. The subsequent image object recognition may therefore enable a communicatively connected server to determine a make and model of hardware captured within the image data.

In another aspect, embodiments of a hosted system or method as disclosed herein may combine additional data such as user-inputted information, user profile information, mobile device telemetry, location information, image metadata, contextual visual information, and the like to further determine hardware product information sufficient to enable registration of the hardware product, such as determining warranty information and compliance, financial valuation of the product such as for insurance valuation, and/or subjective valuation such as user reviews and satisfaction, without requiring user recognition and manual input of all hardware products. Some embodiments may further include hardware sensor and/or token information received via the mobile device, such as hardware product make and model, serial number, installation information, and the like. Further embodiments may prompt users to provide a user review and/or satisfaction score for the identified hardware product which may be transformed and interpreted in accordance with various review site APIs to enable single-source, simultaneous review of the hardware product as submitted across multiple sites and product review aggregators. Still further embodiments may provide users with aggregate reviews and/or satisfaction scores from first-party and third-party sources, such as product review sites and online product retailers.

A conventional embodiment of the systems and methods as disclosed herein may include a software application as executed on a smartphone device with a camera. The software may generally direct a user to capture photos or video of one or more hardware products, including, e.g., fixtures and appliances as may be installed in residential, commercial, or industrial properties. The software may enable the user to capture live images or videos, or alternatively upload previously captured images or videos, of one or more hardware products.

The system may then process the uploaded images and/or videos in accordance with image recognition software and compare the observed hardware products against known hardware to determine a match or, where a single match does not meet a threshold of confidence, a set of matches for subsequent narrowing and/or selection. In an embodiment, the system may present the set of matches for the user to select the appropriate product match. In another embodiment, the system may determine a series of questions to prompt the user in order to narrow the set to subsets or a singular match based upon the user's responses. In yet another embodiment, the system may request additional images or videos sufficient to narrow the determination of products, such as, for example, requesting a picture of a specific feature or at a specific angle.

In one embodiment, the system may determine a subset of potential hardware matches, or alternatively variably adjust threshold confidence matches, based upon image recognition algorithms determining a room match likelihood. For example, the system may identify via image recognition software the presence of a bed in one or more user-submitted images and accordingly categorize the set of images showing the bed as likely to be a bedroom. The system may then further adjust the likelihood of hardware matches for products identified within the likely bedroom in accordance with the statistical or expected prevalence of items in that room, such as, for example, variably reducing the confidence of hardware matches for refrigerators and/or variably increasing the confidence of hardware matches for safes.

Once a hardware product match has been determined, the system may incorporate additional data such as telemetry, geolocational data, user profile data, user input data, and the like as necessary to determine, and automatically populate fields for, registration of the hardware via associated warranty programs. For example, upon determining a make and model, the system may first determine a product registration page for the associated make and model; then further determine from the GPS location data associated with the uploaded images and the user profile information appropriate field population data (e.g., legal name, address, make, model, serial or lot number, purchase date, registration date, etc.). In an embodiment, the system may further or alternatively verify the location data such as WiFi, cellular triangulation, and/or GPS via the smartphone device.

Additionally, the system may prompt the user to submit a product review for the hardware product via the application, such as via a point rating, text description, or both. The system may then format the user's review in accordance with one or more various product review sites or databases, such as adjusting for various point scales and truncating to character or symbol limits, and then submit the user review to the one or more product review sites or databases as a verified owner's review.

In various embodiments, the system may incentivize use of the software platform and registration of multiple devices in one or more sessions. For example, the system may provide gamification and related incentives such as progress bars, rewards, badges, animations, levels, feature unlocks, and other devices for providing a user with psychological gratification for completing registrations. For another example, the system may provide financial incentives such as warranty extensions, replacement or upgrade product discounts, and/or service discounts for registered products.

Referring first to FIG. 1, an exemplary embodiment of a system 100 for computer-assisted identification of hardware products via optically based, software-enabled object recognition and subsequent, software-assisted registration of and user review dissemination of the hardware products via a mobile device as disclosed herein may include a mobile device 101 and a camera 102 operatively or communicatively attached thereto. In various embodiments, the mobile device 101 and camera 102 may be integrated such as in the form of a traditional smartphone or tablet. The mobile device 101 may be further configured to execute an application, the software based locally on the device (e.g., a native application), remotely via a communicatively connected server (e.g., a web application), or in combination of the two (e.g., a hybrid application or a streamed application).

A device user 103 may use the mobile device 101 and camera 102 thereto to capture image data pertaining to a hardware device 104. In various embodiments, the user 103 may take one or more photographs featuring the hardware device 104. In one such embodiment, the user 103 may take photographs of the hardware device 104 in accordance with software instructions for optimizing the processing of the hardware device 104 and identity thereof via object recognition algorithms. For example, the user 103 may be instructed via a user interface to take photographs of the hardware device 104 from various, specific angles (e.g., front, top, left side, right side, etc.).

In another series of embodiments, the user 103 may capture via the camera 102 video of the hardware device 104. The system 100 may in some embodiments retain the video and in other embodiments extract still photographs from the video. In said videographical embodiments, the user 103 may be instructed to pan the camera 102 in specific configurations for best capturing the hardware device 104 for purposes of object recognition processing.

In still another series of embodiments, a plurality of cameras 102 associated with the mobile device 101, such as where the mobile device 101 is equipped with stereoscopic or offset, multifunctional cameras (e.g. prime lens camera, monochrome camera, night vision camera), may be used to capture stereoscopic photographs or videographs of the hardware device 104. In various embodiments, multiple hardware devices 104 may be captured within the same photograph and/or videographs.

In certain embodiments, the system software may be configured to supplement registration of the one or more hardware devices 104 via audio and voice recognition. For example, the system may provide the user 103 with instructions for taking pictures or video with the mobile device 101 and may prompt the user with questions about the hardware device 104. The system may be further configured to receive audio from the mobile device 101, or alternatively the microphone of a computer device communicatively connected to the mobile device 101 such as a home automation hub and process the audio via natural language and speech processing algorithms to determine the user 103's answers. The user 103's answer may further be used to refine the identification of the hardware device 104 in supplementation of the image processing algorithms. For example, the system may ask the user 103 about various features of the hardware device 104.

In various embodiments, the mobile device 101 may be connected to a communications network 105, the communications network 105 further connected to an image processing system 106 with a hardware object database 107 attached thereto. The image processing system 106 may be configured to receive the image data captured via the mobile device 101, analyze the image data in accordance with object recognition algorithms, and determine if any of the images depict one or more hardware devices 104 associated with one or more hardware objects as stored on the hardware object database 107.

For example, a user 103 may capture the image of a kitchen sink via the mobile device 101. The captured image is subsequently uploaded to the image processing system 106, and the image processing system 106 uses image object recognition algorithms to determine that the image of the sink contains a hardware device 104 of a sink and a second hardware device 104 of a faucet. The image processing system 106 may further determine, based on object data stored within the hardware object database 107, that the sink hardware device 104 substantially matches a Kohler Verse 33″×22″×9″, model number K-20060-4-NA, and the faucet hardware device 104 substantially matches a Pfister Cantara Sprayer Faucet, model number F-534-7CRY. In certain embodiments, the system 100 may request that the user 103 verify the image processing system 106's hardware-object identification. For example, if the image processing system 106's algorithms do not result in a match with a sufficiently high confidence threshold, it may request the user 103 select which hardware object identity matches the hardware device 104. In an embodiment, the system 100 may prompt the user 103 with multiple images as displayed upon a user interface upon the mobile device 101, each image corresponding to a potential object match. In another embodiment, the system 100 may determine dispositive questions to ask the user 103, the answers to which will correctly identify the device. For example, where the image processing system 106 is unable to determine between three potential object matches for a refrigerator, it may issue instructions to the application to display on the mobile device 101 one or more questions to the user 103, such as, “Is this a Whirlpool refrigerator?” or “How many shelves are in the refrigerator side?” wherein the response to each question delineates and makes more or less probable possible object matches.

Said questions may be sequential and iterative, thereby narrowing potential object matches based on user responses. The questions may further be prioritized based upon the degree of certainty gained based on the potential answers to be received (i.e. prioritized so as to require as few questions as possible to achieve an object match). In various embodiments, the system 100 may request the user 103 to upload additional image data to assist in object identification in lieu of or in addition to question prompts and image selections. For example, where the profile shape of a handle may be determinant in an object identification, the system 100 may request the user 103 to take a picture of the handle of the hardware device 104 in profile. In respective embodiments, the system 100 may alternatively or in supplement receive audio information from the user 103 regarding the device such as, in similar example, requesting the user 103 describe the handle of the hardware device (e.g. “Is the handle straight or curved?”).

In certain embodiments, the mobile device 101 may further be configured to receive non-visual information communicatively from a hardware token 110 associated with the hardware device 104. The hardware token 110 may generally be a device for transmitting, broadcasting, or narrowcasting preprogrammed information to a sensing device such as the mobile device 101. For example, the hardware token 110 may be a WiFi radio; Bluetooth radio; Zigbee radio; an NFC tag; an iBeacon, Eddystone, or similar proximity beacon; and the like. The hardware token 110 may broadcast information to be read by the mobile device 102 regarding the hardware device 104 such as installation information (e.g. installation details and parameters such as installer identity, installation date, installation method, connected construction materials, grade, affiliate devices, etc.), associated software information (e.g. hardware device firmware, WiFi network information, IP address, etc.), and hardware information (e.g. make, model, serial number, components, etc.). The mobile device 102 may in one embodiment read the hardware token 110 information via one or more sensors comprising or connected to the mobile device 102, or alternatively the mobile device may obtain the hardware token 110 information indirectly via the communications network 105, a separate communications network such as an intranet, and/or network-connected devices, such as, for example, a network-enabled home automation hub.

In various embodiments, the system 100 may further add the user 103's image data and verification response data to the hardware object database 107 in association with the determined hardware-object match to assist with the identification of future iterations of product identification. The image processing system 106 may therefore employ machine learning techniques when iteratively performing image recognition processes.

The hardware object database 107 may further include, for some or all of each hardware object profile stored thereupon, registration information for the associated hardware object. When the image processing system 106 makes a determinative match, or in respective embodiments the user 103 has also verified the determinative match, the system 100 may then direct the display of the registration information on the mobile device 101. In various embodiments, the user 103 may be presented with a registration form, such as, for example, a manufacturer's warranty form for the hardware device 104, whereby the user can verify the registration data and submit it to activate the warranty for the hardware device 104 to a warranty provider registration system 108 connected via the communications network 105. The warranty provider registration system may be a third party such as the hardware manufacturer, or in alternative embodiments may be a first-party device registration system affiliated with the system 100. The form may be auto-populated in accordance with known information about the hardware device 104 and user 103. For example, where all such necessary information to register the product is known (e.g. make, model, user name, address, date of purchase), the form may be automatically filled in and presented to the user for registration, or, alternatively, the data may be automatically submitted on behalf of the user 103 to the warranty provider registration system 108 without requiring user input or verification.

In certain embodiments, the registration information may be determined from contextual data available to the software such as, for example, telemetry determined from the mobile device 101, user profile information as stored on the mobile device 101 or on a user profile server connected to the communications network 105, receipt information from emails or rewards accounts associated with the user 103, and the like.

In certain embodiments, the system 100 may further comprise a hardware device valuation process and platform, wherein the information stored upon the hardware object database 107, registration information, image data, and verification response data may further be compared against data stored in a product valuation database 111 connected to the communications network 105. The system 100 may perform one or more of the following: prompt the user 103, determine from image processing algorithms in association with the image processing system 106, obtain from the hardware token 110, obtain from the hardware object database 107, obtain from the warranty provider registration system 108, and obtain from the review aggregator 109, product valuation information such as hardware age, product quality, hardware reviews, replacement cost, depreciation value, etc. and calculate from the available information an estimated financial valuation for the hardware device 104.

In various embodiments, the system 100 may store and reference additional hardware information in association with the hardware object database 107 and/or other communicatively connected hardware information databases for user 103 reference. For example, the system 100 may provide the user 103 service schedule information and reminders, warranty information, service provider information, user manuals, and the like.

In various embodiments, the system 100 may further prompt the user 103 to provide a product rating for the hardware device 104, such as a point value or written review. In certain embodiments, the user's rating and/or written review may be formatted in accordance with certain and various user review aggregator or review engine standards, such as, for example, reinterpreting a 10-point score (integers 0-9) to other range or qualifier formats (1-10; 1-5; 0-5; 0.0-5.0, 0-100, “bad/okay/good,” etc.) and formatting text reviews to submission requirements (2,000 characters, 250 words, no symbols, UTF-8, no curse words, no prices, etc.). In said embodiments, the system may create multiple, different formatted versions each complying with standards of a particular review aggregator or engine standard and then submit each review to the respective review aggregator or engine 109 via the communications network 105. For example, each review may be formatted in accordance with a review aggregator or engine 109 API, thereby allowing a user's single review to appear on multiple review sites (e.g. Amazon, Lowe's, CNET, Good Housekeeping, etc.).

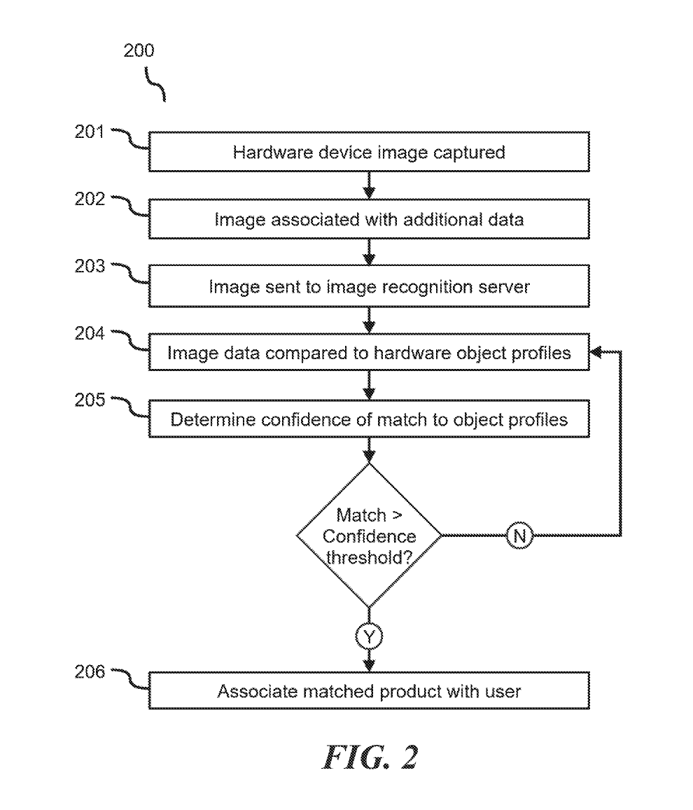

Referring next to FIG. 2, an exemplary method 200 as disclosed herein for optical object recognition and identification of hardware products may be described in part or in whole as follows. The method 200 may begin at a first step 201 wherein a user captures one or more images of a hardware device via a camera associated with a mobile device. In step 202, the image or images are referenced within an application upon the mobile device and associated with relevant data discernable to the application (mobile device sensory data, mobile device telemetry data, user profile data, image metadata, and the like). In step 203, the application sends at least the image or images, and in certain embodiments some or all of the data determined in step 202, to a communicatively connected image recognition server. In one embodiment, the image recognition server may be a communicatively connected server or network of servers, e.g. a cloud-based machine learning engine. In another embodiment, the image recognition server may partially or wholly comprise the mobile device, wherein the mobile device performs part or all of the image recognition processing of step 204.

In step 204, the image recognition server extrapolates data from the images received and compares the data to stored information pertaining to device identification for probabilistic determination of matches between the image and hardware object profiles. This comparison may in various embodiments be made in accordance with machine learning algorithms and deep learning methodologies executed via a neural network. For example, the image recognition server may perform iterative convolution and max pooling to determine: (a) the presence of a hardware product in an image; (b) the type of hardware product present in the image; (c) features of the type of hardware product in the image; (d) feature-based make and model of the type of hardware product in the image. In various embodiments, the image recognition server may make probability assessments of the various match determinations, such as 98% certainty the product is a bathtub faucet; 72% certainty the product is a Speakman brand, 18% probability the product is a Moen brand, etc.

In step 205, the system determines a probability of one or more matches and subsequently presents the one or more match results to the user for verification and refinement. In an embodiment where a match determination is a comparatively high probability of singular match, the system may present the singular match to the user asking them to verify if the match is correct. In various embodiments, the system may present one or more images of the matched product to allow the user to visually compare the products. In iterations where the match determination is not comparatively high probability of a singular match, the system may present product images of a specific make and model determined to be a potential match for user selection. This selection may be iterative, wherein users may assist the image recognition server in the match determination process by verifying positively and negatively the match determinations. In one embodiment, the system may present the highest match and request the user verify the match, and if the user rejects the match, the system then presents the second highest match, etc. This process may be iterative and pursuant to machine learning principles and algorithmically and variably determined weight for identifying positives and negatives, wherein each assertion and rejection strengthens and weakens the confidence of the match, respectively.

The system may present the user with a choice of product features for a user to select as a match, wherein the features correspond to one or more confidence matches that do not meet a certainty threshold. For example, if the image recognition server has identified five possible product matches for a shower and tub faucet, three of which are three-handle products and two of which are two-handle products, the system may present the user with an image of a three-handled faucet and an image of a two-handled faucet with instructions to select which the hardware product is more like. Alternatively, the system may present the same or similar verification in the form of a question: for example: “Is this a three-handled faucet?”; “Is this a three-handled faucet or a two-handled faucet?”; “How many handles are on your faucet?”

The system may repeat steps 204 and 205 iteratively until a match is made of a particular confidence level. In some embodiments, the confidence level may be at the discretion of the user, i.e. where the user directly verifies that the suggested hardware product match is accurate. In other embodiments, the confidence level may be automatically determined based upon a confidence algorithm, wherein a sufficiently high confidence match automatically verifies the match without user input. Continuing the above example, if the user had indicated that the product was a two-handled faucet, the system may then compare the differences between the two two-handled matches and make a clarifying question based upon a determined difference (e.g., “Are the handles chrome or brushed nickel?”).

Upon determination of a verified match, the system proceeds to step 206 and associates the matched product with the user. For example, the system may store the product model number, SKU, or the like in association with the user's user profile or account.

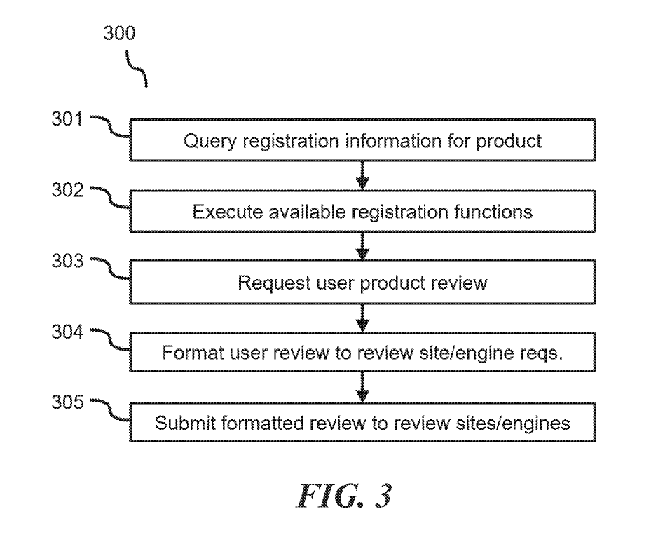

Referring next to FIG. 3, an exemplary method 300 as disclosed herein for assisting a user in registering and reviewing the identified hardware products may be described in part or in whole as follows. The method 300 begins at a first step 301 when a user verifies a product match. In various embodiments, method 300 may be performed concurrently with step 206 of method 200 and following a verification made in the final step 205 of an iteration of method 200. In step 301, the system queries for registration information associated with the identified hardware product. In an embodiment, the system may query and retrieve registration information as stored as part of the hardware object profile. For example, the hardware object profile may have a unique URL directing to a warranty registration page, or alternatively a non-unique URL with field population instructions specific to the hardware object.

In step 302, the system determines from the registration information for the identified hardware product if and what registration function is available and executes the available registration instructions. For example, the system may automatically load a URL for a warranty registration for a washing machine, auto-populate the known warranty fields, and, if sufficiently complete, automatically submit the warranty registration. Other methods of information submission may be used, including API calls. The system may further prompt the user for missing but critical information. If no registration function is available, the system may alert the user that registration cannot be completed.

In step 303, the system prompts the user to provide a review of the hardware product. The review may be in the form of a quantitative rating (i.e. scale of 1.0 to 5.0) and/or a qualitative written assessment (i.e. a summary).

In step 304, the system formats the user-submitted review in accordance with one or more review site or engine submission parameters. For example, the system may adjust the rating scale to a different numeric range and/or may format the text review parameters to format paragraphs, symbols and the like, such that the rating can be submitted in accordance with API for the review site or review engine. For further example, the system may prompt the user to submit pros and cons in separate text fields but may truncate these fields for review engines which provide only a single text field response.

In step 305, the system submits each of the formatted versions of the user reviews to the respective review sites, simultaneously publishing the user's review to various information indexes. In an embodiment, the system may further identify outlier reviews, such as unusually high or unusually low reviews, and alert the manufacturer to such review. In a further embodiment, the system may employ machine learning techniques to identify review trends based upon known product information and known aggregate information. For example, the system may identify a particular lot of hardware products with unusually low reviews, suggesting a potential manufacturing defect with the lot, and warn the manufacturer of the hardware product lot to this trend identification. As another example, the system may identify that ratings are particularly high for geothermal heating units in the northeast of the United States, suggesting higher marketability in that region.

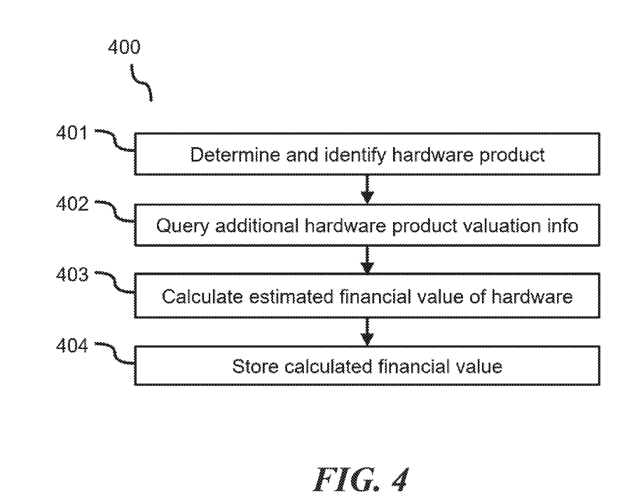

Referring now to FIG. 4, an exemplary method 400 as disclosed herein for determining a financial valuation of hardware products may be described in whole or in part as follows. The method 400 begins at a first step 401 wherein the system determines and identifies a hardware product. The identification of the product may be in accordance with software and object recognition algorithms and in various embodiments may exemplarily be described in accordance with one or more steps of method 200. Upon determination of the hardware product, the system may further query additional valuation information (step 402). Additional valuation information may include hardware- and installation-specific data such as, but not limited to, age, quality, reviews, MSRP, replacement cost, installation information, and the like. The system may query the valuation information from the user, other communicatively connected databases, processed image data, and algorithmically determined estimates. For example, the system may prompt the user to specify the installation date of the hardware, may estimate the condition of the hardware based on an image processing algorithm for determining the condition of the unit (e.g. estimating presence of rust), may query review data from first-party or third-party reviews, may determine warranty coverage information from the manufacturer's warranty database cross-referenced with the specified age of the unit, and may determine the replacement cost from third-party sellers. The system may reference third-party data via one or more APIs. The system may further determine replacement cost from cost estimation algorithms by identifying comparable hardware products and averaging purchase price for such comparable products.

The system then calculates an estimated financial value for the user's identified hardware in accordance with one or more financial evaluation algorithms (step 403). The system may, for example, determine the standard retail price of the hardware and then subtract dollar value based on value-reducing factors such as age, condition, and the like. Alternatively, the system may determine one or more comparable products to replace the hardware product and determine an estimated cost based upon an average of the comparable product costs. In an embodiment, the variables for the variable stores or variable weighting for the one or more financial value factors can be user-adjustable or administrator-adjustable so as to more accurately represent effective valuation.

In step 404, the system stores the calculated financial value of the hardware in association with the hardware and user. The system may display the calculated financial value of the hardware for the user upon user request. The system may also provide the calculated financial value to other authorized users. For example, the system may permit a user to share financial valuation information of the user's home hardware with an inspector, appraiser, realtor, etc. Similarly, a user who is a builder, contractor, or landlord may elect to share the financial valuation information with a homeowner or renter. The system may be further configured to aggregate the estimated value of one or more hardware devices in a geographic location, such as for calculating home insurance estimates.

The system may further provide the user with incentives for replacement hardware or hardware upgrades. For example, the system may provide affiliate links to third-party sellers, coupons for product replacements, offers by hardware technicians for service and repair, etc. The system may selectively determine which incentives to provide a user based upon the financial valuation or condition of one or more financial valuation factors. For example, the system may determine that a user should be incentivized to replace a hardware device that has surpassed a certain age limit and may, therefore, advertise replacement options suitable for the user in accordance with installation-specific factors, user profile factors, comparable hardware features, comparable replacement costs, and the like.

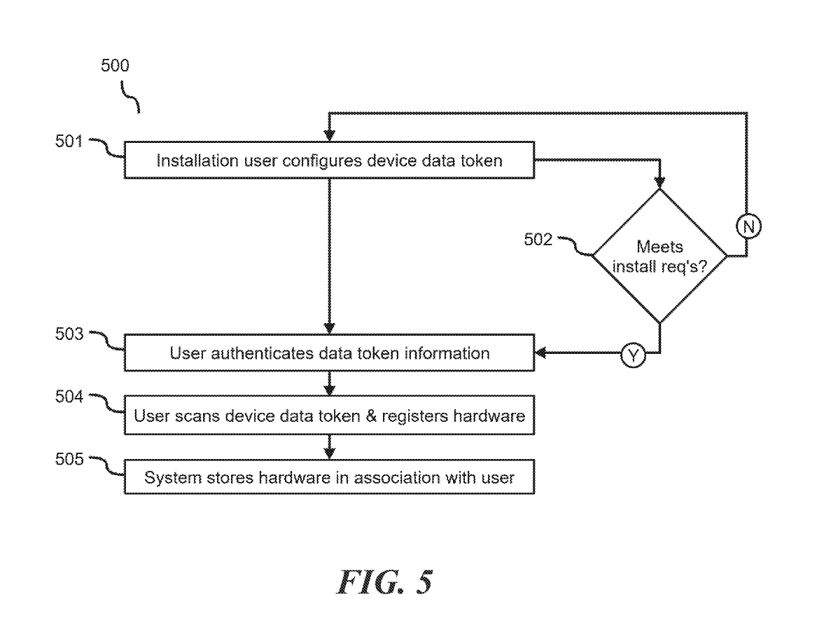

Referring now to FIG. 5, an exemplary method 500 for configuring a hardware device upon installation for assisted user registration may be described in whole or in part as follows. The method 500 begins at step 501 wherein an installation user configures a device data token with product and installation formation for the hardware device. The hardware device data token may be a physical broadcast token such as a beacon, NFC tag, or computer system with one or more wireless radios to be read by an external device sensor. The installation user may be, for example, a contractor, subcontractor, builder, hardware installer, hardware manufacturer, etc. The installation user may configure the device data token with hardware device-specific information such as hardware make, model, serial number; with user-specific information such as installer ID, installer company, installer account, installer credentials; with installation-specific information such as associated construction materials (e.g. subfloor type, mounting hardware, connected plumbing configuration, connected electrical wiring configuration, grade, floorplan, etc.); and with network-specific information such as associated software, firmware, IP address, broadcast information, associated other hardware, etc.

In an embodiment, the system may optionally verify the installation-user provided information with one or more installation requirements (step 502) and prevent completion of verification or otherwise generate an alert to the installation user if the installation-user provided information does not meet the criteria of the one or more installation requirements. For example, the system may alert the installation-user if the installation of the hardware does not meet the criteria for warranty coverage, local building codes, compliance requirements, etc. The system may prevent the user from moving forward to step 502 until the user provides installation information that is compliant with one or more of the foregoing criteria.

In step 503, the user may authenticate the data token information via the system software. In various embodiments, step 503 may be interpreted in accordance with method 200 and/or 300. In an embodiment, the installation user may perform step 503 when installation of one or more hardware products is complete. For example, an installation user may verify all of the relevant hardware devices following buildout of a commercial building, thereby associating the hardware therein with the commercial building, the associated hardware profile for the building to be shared with or provided to one or more other users such as a realtor, inspector, appraiser, tenant, repairperson, etc. In relevant embodiments, authentication of the data token information may add the hardware information for the associated hardware to the hardware object database.

In step 504, a user may scan the hardware data token using a fixed or mobile sensor device, such as for example scanning a beacon or NFC tag with a smartphone and register the hardware device in association with the user. For example, a user may be a homeowner who has recently purchased a home and is activating and associating the home hardware previously configured and authenticated by the home contractor.

The system may accordingly associate the hardware for the associated hardware data token with the user (step 505). The system may optionally populate or adjust additional device information such as financial valuation, service information, etc. in accordance with the combination of hardware data token information and user information. For example, the system may determine the start of a warranty period, a recommended service cycle, integrations and interactions with other user-associated hardware, etc. For further example, the system may provide the user with suggested home automation interactions between the hardware registered in step 504 and other user-registered hardware. The system may further provide the user with device-specific information such as instructions, user manuals, associated authorized service providers, and the like.

Depending on the embodiment, certain acts, events, or functions of any of the algorithms described herein can be performed in a different sequence, can be added, merged, or left out altogether (e.g., not all described acts or events are necessary for the practice of the algorithm) Moreover, in certain embodiments, acts or events can be performed concurrently, e.g., through multi-threaded processing, interrupt processing, or multiple processors or processor cores or on other parallel architectures, rather than sequentially.

Various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

Various steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

The term “user interface” as used herein may unless otherwise stated include any input-output module with respect to the hosted server including but not limited to web portals, such as individual web pages or those collectively defining a hosted website, mobile applications, desktop applications, mobile applications, telephony interfaces such as interactive voice response (IVR), and the like. Such interfaces may in a broader sense include pop-ups or links to third party websites for the purpose of further accessing and/or integrating associated materials, data or program functions via the hosted system and in accordance with methods of the present invention.

The term “communications network” as used herein with respect to data communication between two or more parties or otherwise between communications network interfaces associated with two or more parties may refer to any one of, or a combination of any two or more of, telecommunications networks (whether wired, wireless, cellular or the like), a global network such as the Internet, local networks, network links, Internet Service Providers (ISP's), and intermediate communication interfaces.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A system comprising:
one or more data collectors configured to capture at least identification data for one or more hardware products in a defined area; and
a server configured to
automatically identify each of the associated one or more hardware products based on the at least identification data from the one or more data collectors, further in association with a time at which the at least identification data was captured and an authenticated location of the defined area with respect to the one or more hardware products, and
selectively actuate one or more program applications via a user computing device located in the defined area, each program application respectively associated with one or more of the identified one or more hardware products.

2. The system of claim 1, wherein at least one of the one or more data collectors is an imaging device configured to capture one or more images of at least one of the hardware products, and the server is configured to automatically identify the at least one hardware product in the captured one or more images via at least image recognition processing and contextual data associated with the captured image.

3. The system of claim 1, wherein at least one of the one or more data collectors is fixed in position with the respect to the defined area and comprises a wireless transceiver configured to receive wireless messages comprising the at least identification data from one or more of the hardware products.

4. The system of claim 3, wherein the at least one fixed data collector is configured to capture the at least identification data from the wireless messages from the one or more of the hardware products pursuant to a received audio command.

5. The system of claim 4, wherein the at least one fixed data collector is configured to audibly prompt additional capture of the at least identification data for one or more hardware products in the defined area, via a mobile user computing device as another of the one or more data collectors,
wherein the mobile user computing device comprises an imaging device configured to capture one or more images of at least one of the hardware products, and
the server is configured to automatically identify the at least one hardware product in the captured one or more images via at least image recognition processing and contextual data associated with the captured image.

6. The system of claim 5, wherein the server is configured to prompt a user via the at least one fixed data collector or a user interface associated with the mobile user computing device to capture one or more additional images until a confidence level is acquired in the hardware product identification.

7. The system of claim 5, wherein the server is configured to compare a first set of identified hardware products based on the wireless messages received via the at least one fixed data collector against a stored plurality of expected hardware products in the defined area, and further to direct the at least one fixed data collector to audibly prompt additional capture of the at least identification data for at least a remaining second set of hardware products of the stored plurality of expected hardware products.

8. The system of claim 1, wherein at least one of the one or more data collectors comprises an imaging device associated with a first mobile user computing device, and the first mobile user computing device further comprises a position sensor for server-based authentication of the location of the defined area with respect to the identified one or more hardware products at a first time, and
wherein the server is configured to selectively actuate one or more program applications via a second mobile user computing device authenticated as being located in the defined area at a second time, each program application respectively associated with one or more of the identified one or more hardware products.

9. The system of claim 1, wherein the server is configured in association with at least one of the selectively actuated program applications to
determine one or more of the identified one or more hardware products for online submission of hardware product information to an insurance entity platform,
selectively prompt a user via at least one of the one or more data collectors or the user computing device to provide at least a position authentication with respect to the determined one or more of the identified one or more hardware products, within a specified period of time, and
submit the hardware product information to the insurance entity platform along with the time-based position authentication.

10. The system of claim 9, wherein the server is configured in association with at least one of the selectively actuated program applications to
transmit hardware product information for the identified one or more hardware products to a valuation platform, and
pursuant to an updated valuation associated with the defined area and received from the valuation platform, to submit the updated valuation to the insurance entity platform along with the time-based position authentication.

11. The system of claim 1, wherein the server is configured to
determine one or more of the identified one or more hardware products for which registration is available on one or more registration platforms, and
in association with at least one of the selectively actuated program applications, generating registration data transmittal for one or more of the identified one or more hardware products to the one or more registration platforms.

12. The system of claim 11, wherein the server is configured to prompt a user, via at least one of the one or more data collectors or a user interface associated with the mobile user computing device, for additional information associated with registration of the determined one or more hardware products, based at least on defined input requirements for any one or more of the registration platforms.

13. The system of claim 1, wherein the server is configured in association with at least one of the selectively actuated program applications to
determine one or more of the identified one or more hardware products for which online submission of user review is available on one or more third party product review aggregating platforms, and
generate one or more product reviews from a single user input string associated with an identified hardware product, based at least on the respective review data input requirements for each of the respective one or more third party product review aggregating platforms, and to distribute the plurality of product reviews to the respective one or more third party product review aggregating platforms.

14. A system comprising:
a server linked via a communications network to a computer program product residing on a computer readable medium of a user computing device;
wherein the computer program product is executable by a processor further residing thereon to generate a user interface on a display associated with the user computing device;
wherein the server is configured to
automatically identify one or more hardware products in a captured image received from the user computing device via the communications network, via at least image recognition processing and contextual data associated with the captured image via the computer program product,
generate registration data transmittal for one or more of the identified one or more hardware products to one or more third party registration platforms, and
enable user input regarding one or more of the identified one or more hardware products via the user interface, for review message transmittal to one or more third party product review aggregating platforms.

15. The system of claim 14, wherein the server is configured to prompt a user via the user interface to capture one or more additional images until a confidence level is acquired in the hardware product identification.

16. The system of claim 14, wherein the server is configured to determine one or more of the identified one or more hardware products for which registration is available on the one or more third party registration platforms.

17. The system of claim 16, wherein the server is configured to prompt the user via the user interface for additional information associated with registration of the determined one or more hardware products, based at least on input requirements for any one or more of the third party registration platforms.

18. The system of claim 16, wherein the server is configured to automatically generate and upload registration data transmittal for one or more of the hardware products based at least on current information from the user computing device and input requirements for any one or more of the third party registration platforms.

19. The system of claim 14, wherein the server is configured to determine one or more of the identified one or more hardware products for which online submission of user review is available on the one or more third party product review aggregating platforms.

20. The system of claim 19, wherein the server is configured to generate a plurality of product reviews from a single user input string associated with a hardware product, based at least on the respective review data input requirements for each of a plurality of third party product review aggregating platforms, and to distribute the plurality of product reviews to the respective third party product review aggregating platforms.
